(19) United States
(12) Patent Application Publication
(10) Pub. No.: US 2004/0209689 A1
(43) Pub. Date: Oct. 21, 2004

(54) Game controller with a sound device for a video game player

(75) Inventors: Chi Fu Peng, Chungli City (TW); Chiu Hao Cheng, Miaoli Hsien (TW); Ming Gwo Cheng, Taichung Hsien (TW)

Correspondence Address: BACON & THOMAS, PLLC, 625 SLATERS LANE, FOURTH FLOOR, ALEXANDRIA, VA, 22314

(73) Assignees: ZEROPLUS TECHNOLOGY CO., LTD., Chungho City (TW); VISION ELECTRONICS CO., LTD., Chungli City (TW)

(21) Appl. No.: 10/414,402

(22) Filed: Apr. 16, 2003

(51) Int. Cl. A63F 13/02

(52) U.S. Cl. 463/37

(57) ABSTRACT

A game controller with a sound device for a video game player comprises a control circuit, an amplifier, a microphone, a sound transmission wire and a communication interface. The sound device is connected to a second memory chip receiver of the game controller, and the sound device is connected with the first memory chip receiver of the game controller by a sound transmission wire. The user can communicate with the other online players using the amplifier and microphone of the sound device, which is positioned in the second memory chip receiver. Therefore the user need not wear the headset with microphone for communicating with the other online players, thus the game controller of the present invention provides increased fun and convenience of playing the game.

### BACKGROUND OF THE INVENTION

1. The Field of the Invention

The present invention relates to a video game player, and more particularly relates to a game controller with a sound device comprising a sound transformer for a sound device, which is connected to connected with a first and second memory chip receivers of the game controller. The built-in microphone and the amplifier of the sound device allow the user to use the game controller to transmit signals and communicate with the other online players. Thus without using headset with microphone, the user can control the game controller and also communicate with the other online player within an effective transmission range.

2. Description of the Related Art

Nowadays, online game is very popular and all the manufacturers of game players continue developing newer game players for the recreation of on-line users. For capitalizing the market, the manufacturers of game players provide various peripheral products for facilitating the video game player in view of user friendly control and convenience, for example, some manufacturers have design a headset with microphone in order to allow the user to communicate with other online game players in order to create more fun for the online users while playing the game.

Referring to FIGS. 1A, 1B, 1C and 2, show a conventional video game player. As shown, the video game system A10 (XBox of Microsoft) comprises a controller A20, a sound transformer A30, and a sound device A40. The sound device A40 comprises a headset A41 with microphone A42 particularly for the online game. A first memory chip receiver A22 of the controller A20 is for receiving the sound transformer A30 with an external card bus, and the sound transformer A30 is used as a communication medium between the second communication interface A35 and the controller A20. A sound transmission wire A43 is used as a communication medium between the headset A41 with microphone A42 and the headset jack A34 with sound transformer A30. Thus the first control circuit A21 and first communication interface A25 of the controller A20 is able to communicate with the video game system A10. Further, the controller A20 comprises a second memory chip receiver A23 and a button A24, wherein the second memory chip receiver A23 is a prescribed slot and the button A24 is for controlling the game and for switching the functions. The sound transformer A30 comprises a second control circuit A31, a volume control button A32 and a microphone switch A33. The volume control button A32 is for controlling the volume of the headset and the microphone switch A33 is for turning the microphone A42 on or off through the second control circuit A31.

However, the above conventional video game player has several defects as follows:

1. The specification of the headset A41 and the microphone A42 are different from the one available in the market, and therefore the user has to purchase the video game player together with the sound transformer A30 as a set if any one of the headset A41 or microphone A42 is out of order. Therefore, it is expensive for the user to replace the whole video game player.

2. The headset A41 and microphone A42 need to communicate with sound transformer A30 through the sound transmission wire A43, thus could cause inconvenience to the user, for example, entanglement of the sound transmission wire A43 and/or limited length of the sound transmission wire A43, while using the controller A20.

3. The headset A41 and microphone A42 are directly held on the user's ear, this would be uncomfortable to the user after long-hour usage due to the weight of the headset A41 and microphone A42.

4. The user is unable to move freely because of the sound transmission wire A43 and controller transmission wire.

5. The user is unable to control the volume and turning the microphone A42 on or off instantly, thus the fun of playing by such controller A20 will not be as much as desired.

Therefore, it is highly desirable to improve the video game player in order to overcome the above defects of the prior art.

### SUMMARY OF THE INVENTION

Accordingly, in the view of the foregoing, the present inventor makes a detailed study of related art to evaluate and consider, and uses years of accumulated experience in this field, and through several experiments, to create a new game controller with a sound device for a video game player. The present invention provides an innovated cost effective game controller with a sound device for a video game player, which would allow the user to control the game controller wirelessly within an effective range providing great convenience and recreation to the user while playing the game.

In accordance with the above objects and other advantages of the present invention, a game controller with a sound device for a video game player comprising a control circuit, an amplifier, a microphone, a sound transmission wire and a communication interface. The sound device is connected to a second memory chip receiver of the game controller, and the sound device is connected with the first memory chip receiver of the game controller by a sound transmission wire. The user can communicate with the other on line players using the amplifier and microphone of the sound device, which is positioned in the second memory chip receiver. Therefore the user need not wear the headset with microphone for communicating with the other online players, thus the game controller of the present invention provides increased fun and convenience of playing the game.

According to an aspect of the present invention, is that the sound device can communicate with the game controller through the second memory chip receiver of the game controller and further to gain the needed power supply. With the electrical connection between the headset jack connected at one distal end of the sound transmission wire and the sound transformer positioned in the first memory chip receiver, the sound transformer and the sound device are able to have mutual transmission and receiving for the sound signals and data, thus to enable the user to communicate with other online players without wearing headset and microphone.

According to another aspect of the present invention, the amplifier and microphone are built-in inside the game controller, for adjusting the volume of the amplifier and switching on or off the microphone, the signals generated while the user operates on the volume control button and microphone switch of the sound transformer will be transmitted in orderly to the second control circuit, headset jack, then to the first control circuit through the sound transmission wire, and finally to have the first control circuit control the volume and the microphone switch of the amplifier, thus to enable the user to communicate with other online players without wearing headset and microphone.

### BRIEF DESCRIPTION OF THE DRAWING

For a more complete understanding of the present invention, reference will now be made to the following detailed description of preferred embodiments taken in conjunction with the accompanying drawings, in which:

FIG. 1A is an elevational view of a conventional video game player with a headset;

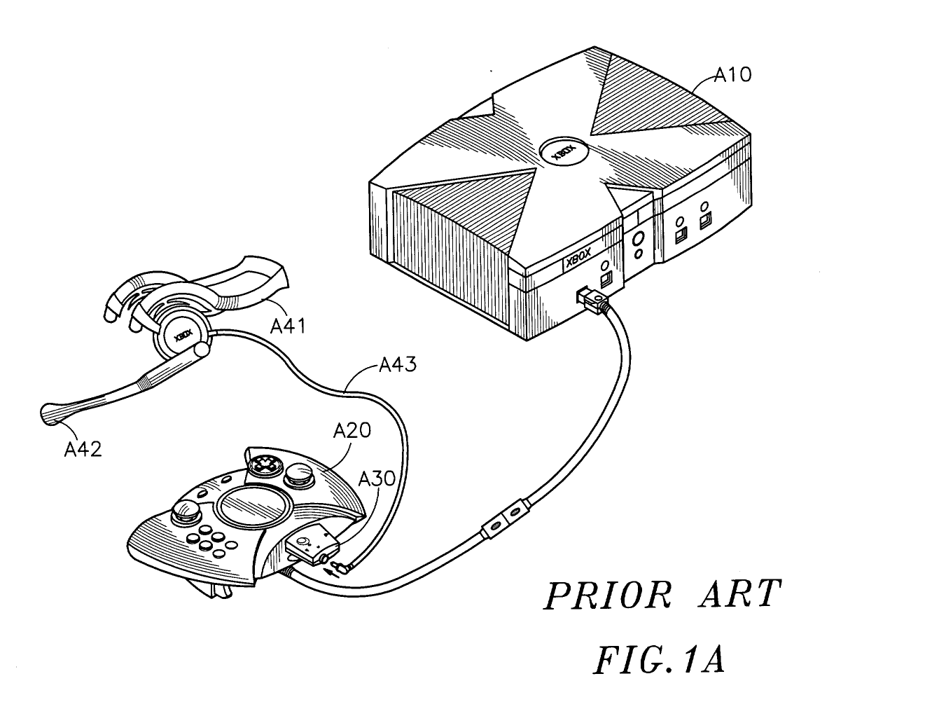

FIG. 1B is an elevational view of a controller and a sound transformer of the conventional video game player;

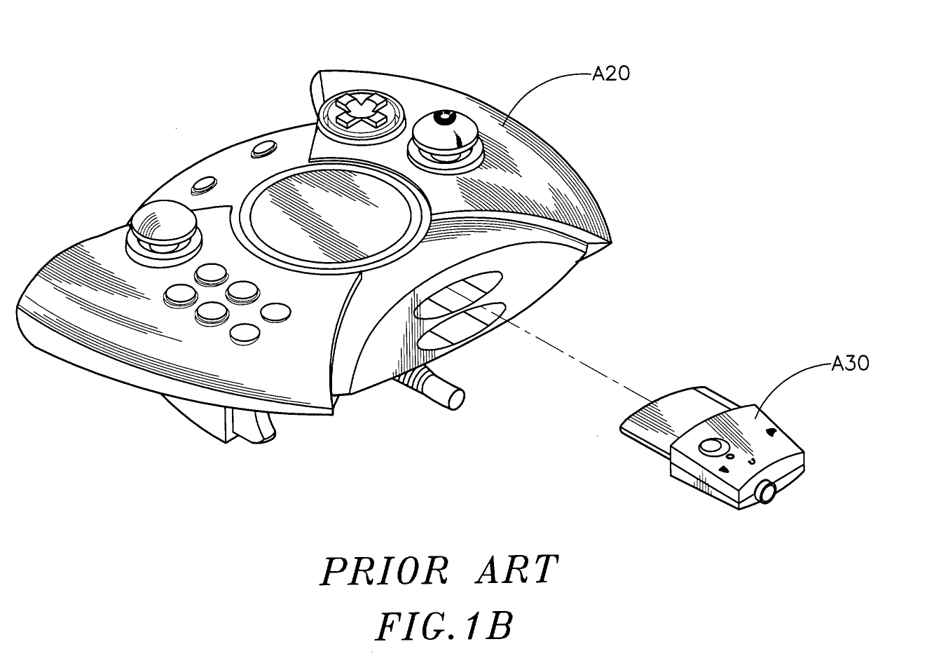

FIG. 1C is a perspective view of a headset of the conventional video game player;

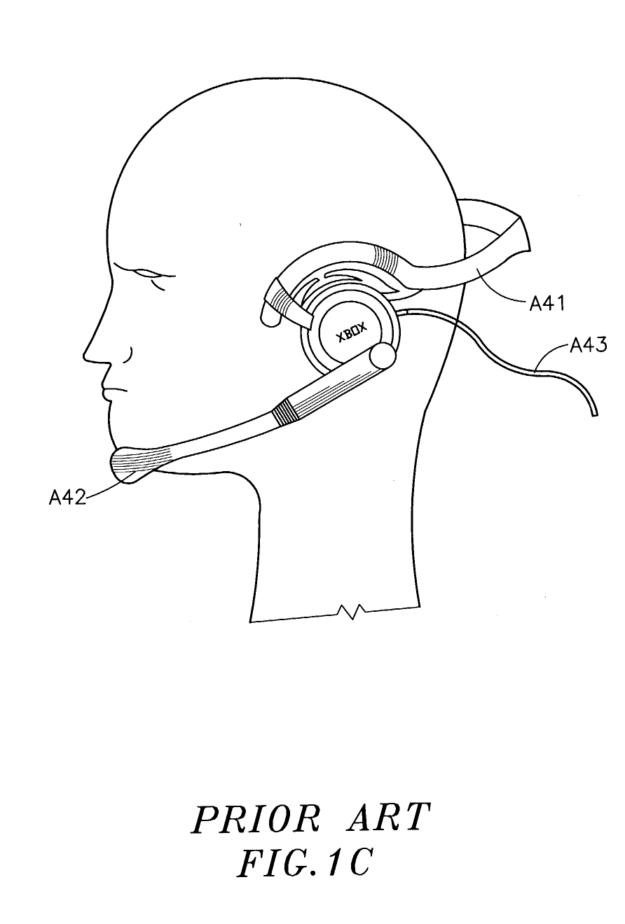

FIG. 2 is an actual functioning flow chart of the video game player according to the prior art;

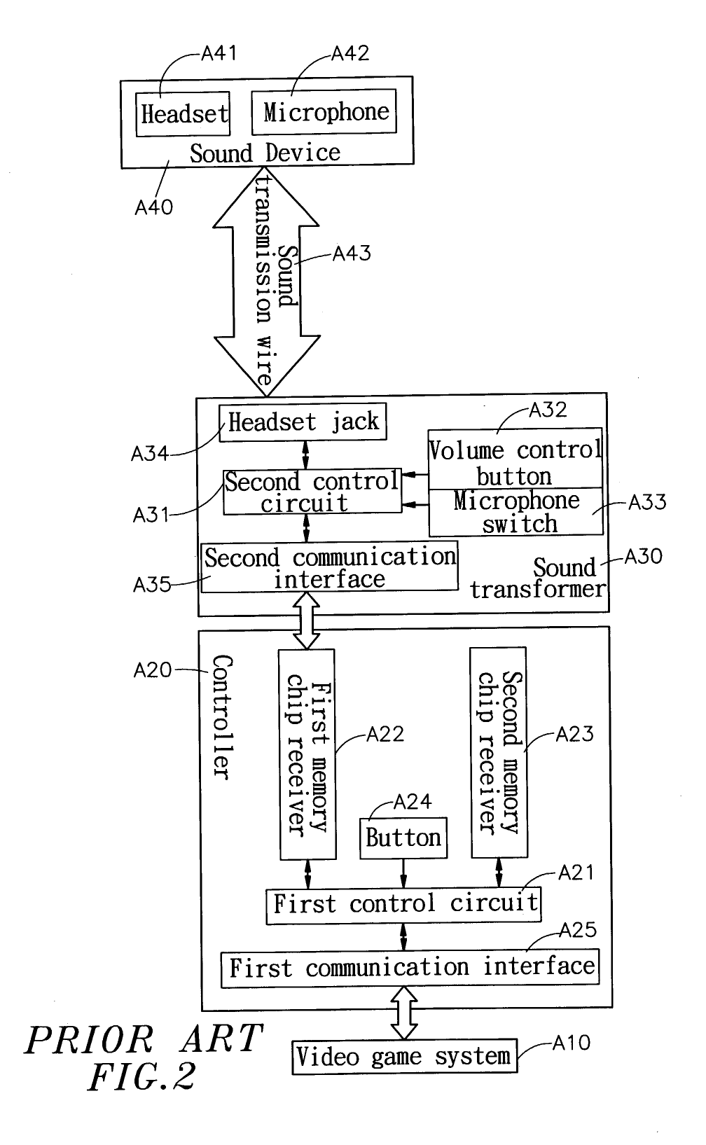

FIG. 3 is an elevational view of a video game player according to one preferred embodiment of the present invention;

FIG. 4 is an actual functioning flow chart of the video game player according to the preferred embodiment of the present invention.

FIG. 5 is an elevational view of a video game player according to another preferred embodiment of the present invention; and

FIG. 6 is an actual functioning flow chart of the video game player according to another preferred embodiment of the present invention.

### DETAILED DESCRIPTION OF PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

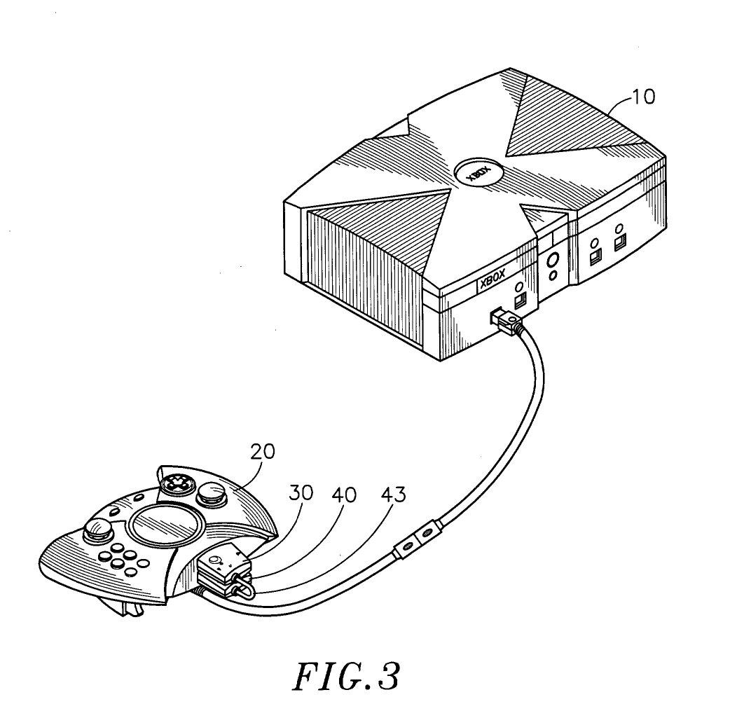

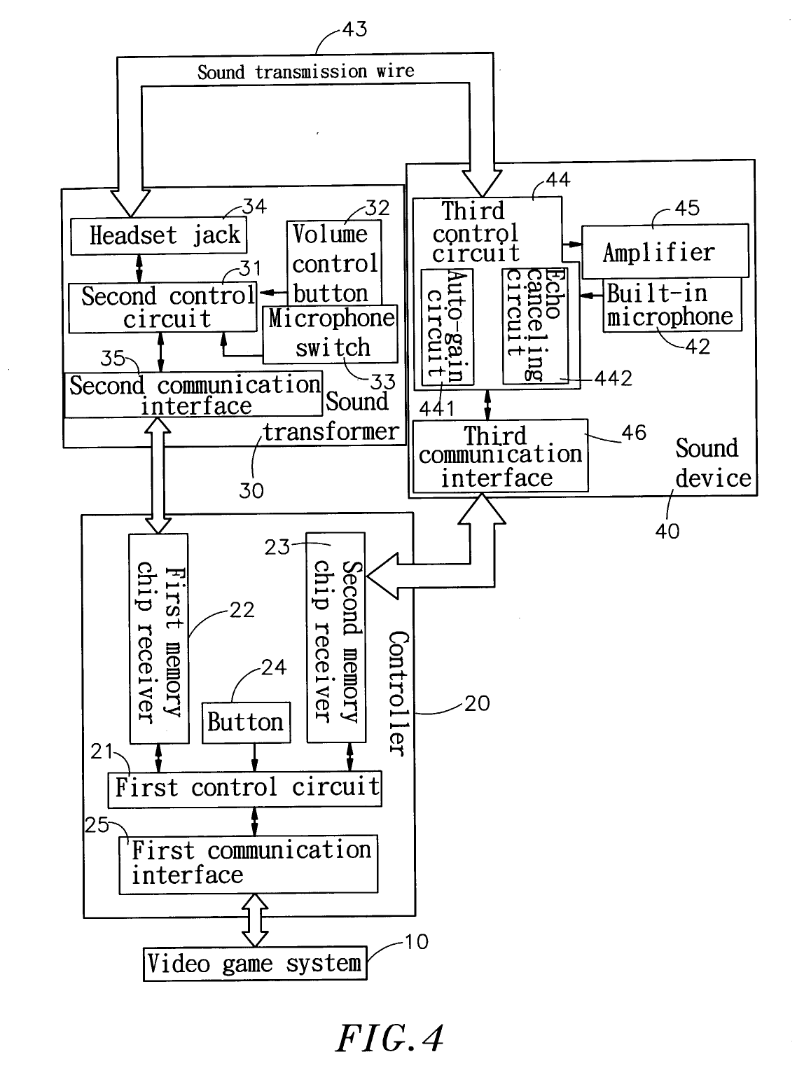

Referring to FIGS. 3 and 4, the video game player comprises a video game system 10 and a game controller 20, wherein the video game system 10 is connected to the game controller 20. The game controller 20 is connected to a sound transformer 30 and a sound device 40.

The game controller 20 comprises a first control circuit 21, a first memory chip receiver 22, a second memory chip receiver 23, a button 24 and a first communication interface 25, wherein the first memory chip receiver 22, the second memory chip receiver 23, the button 24 and the first communication interface 25 are connected with the first control circuit 21, and wherein the first memory chip receiver 21 is for receiving the sound transformer 30, and the second memory chip receiver 23 is for receiving the sound device 40.

The sound transformer 30 comprises a second control circuit 31, a volume control button 32, a microphone switch 33, a headset jack 34 and a second communication interface 35 connecting with said second control circuit 31, wherein said headset jack 34 is connecting with the third control device 44 of the sound device 40 by a sound transmission wire 43.

The sound device 40 comprises a third control circuit 44, an amplifier 45, a microphone 42, a sound transmission wire 43 and a third communication interface 46. The third control circuit 44 is for receiving the sound signals transmitted by the sound transformer 30 and also for receiving the sound signal input by the user and transmitted by the built-in microphone 42 through the sound transmission wire 43, furthermore, the amplifier 45 is for receiving the sound signals transmitted by the third control circuit 44.

As mentioned above, according to one preferred embodiment of the present invention, the game controller 20 is connected to the video game controller 10, the first memory chip receiver 22 of the game controller 20 is for receiving a sound transformer 30 and the headset jack 34 is connected to the first memory chip receiver 22 using a sound transmission wire 43 on the third control device 44 of the sound device 40.

While in actual functioning of the game controller 20 the present invention, the signals input by the button 24 on the game controller 20 are output in orderly manner to the first control circuit 21 then to the video game system 10 through the first communication interface 25.

According to another preferred embodiment of the present invention, when the user operates the volume control button 32 and the microphone switch 33 for adjusting the volume of the amplifier 45 and for switching on or off the microphone 42 of the sound device 40, the signals generated by the user's operation goes in orderly manner to the second control circuit 31, the headset jack 34, then to the third control circuit 44 through the sound transmission wire 43.

According to another preferred embodiment of the present invention, the third control circuit 44 comprises an auto-gain circuit 441 and an echo canceling circuit 442, wherein the auto-gain circuit 441 is for balancing over loud or low volume, and the echo canceling circuit 442 is for canceling the cross talk.

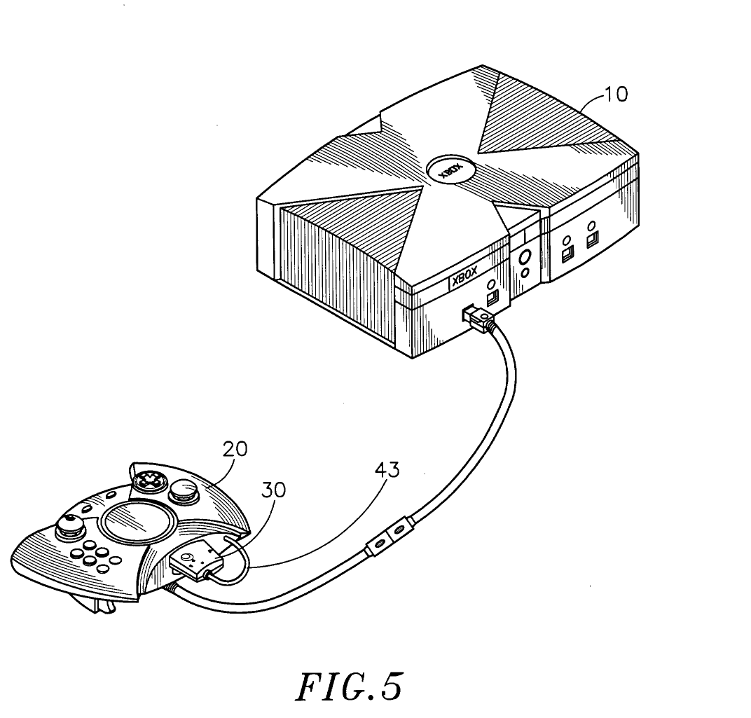

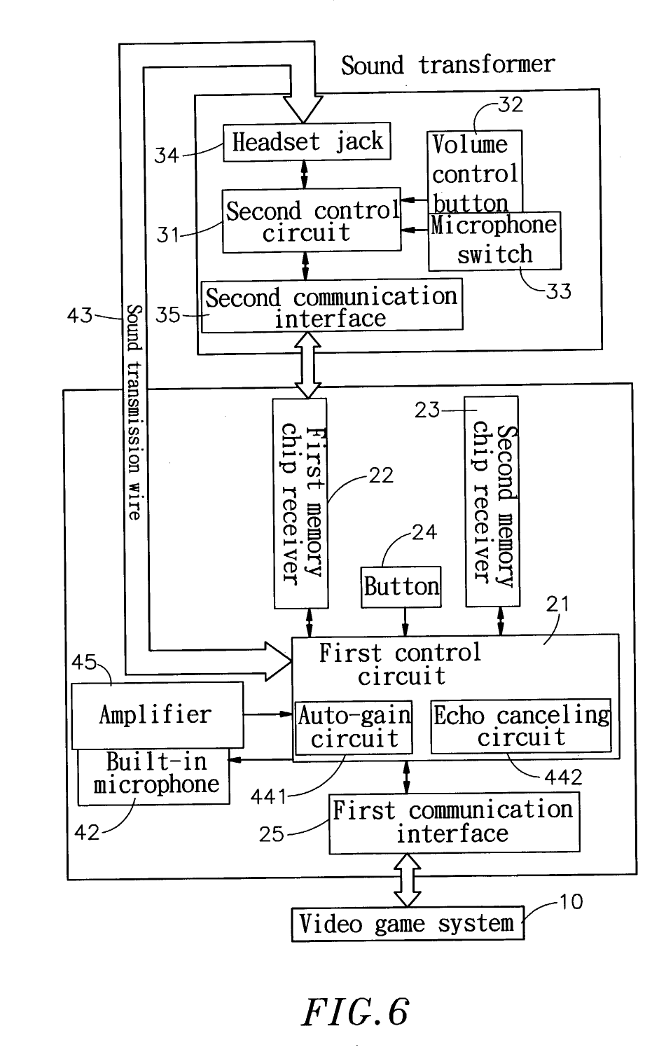

Now referring to FIGS. 5 and 6, the amplifier 45 and the microphone 42 are directly built in the game controller 20, and therefore the user can operate the volume control button 32 and the microphone switch 33 for adjusting the volume of the amplifier 45 and for switching on or off the microphone 42 of the sound device 40 respectively, and the signals generated by the user's operation are transmitted in an orderly manner to the second control circuit 31, the headset jack 34, then to the third control circuit 44 through the sound transmission wire 43.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. A game controller with a sound device for a video game player comprising:
a game controller comprising a first memory chip receiver, a second memory chip receiver and a button, wherein said first memory chip receiver is for receiving a sound transformer, wherein said sound transformer comprises a second control circuit, a volume control button, a microphone and a headset jack, and wherein the volume control button, the microphone and the headset jack are connected to said second control circuit;
a sound device connected to said second memory chip receiver of said game controller, comprising a third communication interface, a third control circuit, an amplifier, a microphone and a sound transmission wire, wherein the amplifier, the microphone and the sound transmission wire are connected to said third control circuit, wherein said third communication interface is received by said second memory chip receiver of said game controller, and wherein said third control circuit connects to said headset jack of said sound transformer through said sound transmission wire, so that said sound transformer can transmit signals through said sound transmission wire to said third control circuit of sound device, and said third control circuit can be used for controlling a volume of the said amplifier or for turning the microphone on or off.

2. The game controller with a sound device for a video game player according to claim 1, wherein said third control circuit comprises an auto-gain circuit for balancing over loud or low volume.

3. The game controller with a sound device for a video game player according to claim 1, wherein said third control circuit comprises an echo canceling circuit for canceling the cross talk.

4. A video game player comprising:
a video game system;
a game controller comprising a memory chip receiver, a first communication interface, a button, an amplifier and a microphone, wherein said video game controller is connected to said video game system through said first communication interface and a sound transformer through a second communication interface of a sound transformer through said memory chip receiver, wherein said sound transformer comprises a second control circuit, a volume control button, a microphone switch and a headset jack, wherein the volume control button, the microphone switch and the headset jack are connected to said second control circuit, wherein the memory chip receiver, the button and the microphone are connected to said first control circuit, and wherein said first control circuit connects to said headset jack through a sound transmission wire, so that signals from said sound transformer can be transmitted through said sound transmission wire to said first control circuit to control a volume of said amplifier and to turn the microphone on or off.

5. The video game player according to claim 4, wherein said first control circuit comprises an auto-gain circuit for balancing over loud or low volume.

6. The video game player according to claim 4, wherein said first control circuit comprises an echo canceling circuit for canceling the cross talk.
